(19) United States
(12) Patent Application Publication
(10) Pub. No.: US 2023/0034475 A1
(43) Pub. Date: Feb. 2, 2023

(54) SYSTEM SERVICE SHARING BETWEEN ENDPOINT DEVICES FOR INCREASED ENDPOINT DEVICE CAPABILITY

(71) Applicant: GOOGLE LLC, Mountain View, CA (US)

(72) Inventors: Michael H. Tsao, San Mateo, CA (US); Daniel Nishi, Mountain View, CA (US); Liza Ma, Sunnyvale, CA (US); Yuk Yin Maurice Lam, Sunnyvale, CA (US); Tyler Kugler, Palo Alto, CA (US); Taylor Bessette, San Jose, CA (US)

(21) Appl. No.: 17/789,738

(22) PCT Filed: Aug. 17, 2021
(86) PCT No.: PCT/US2021/046279

§ 371 Date: Jun. 28, 2022

Related U.S. Application Data
(60) Provisional application No. 63/066,602, filed on Aug. 17, 2020.

(51) Int. Cl. H04L 67/51

(52) U.S. Cl. CPC H04L 67/51

(57) ABSTRACT

An endpoint device system is implemented for the sharing of one or more system services between one or more endpoint devices. The system includes a first endpoint device running an application and configured to detect one or more other endpoint devices communicatively coupled to the first endpoint device. From at least one of the detected endpoint devices, the first endpoint device requests a respective list of available system services. After determining one or more applicable system services based on the application being run, the first endpoint device requests available resolutions for the applicable system services from the detected endpoint devices. The first endpoint device then implements the functionality of the application using one or more of the applicable system services based on the available resolutions.

### CROSS-REFERENCE TO RELATED APPLICATIONS

The present application claims the benefit of U.S. Provisional Patent Application Ser. No. 63/066,602, entitled “SYSTEM FOR GAINING CAPABILITIES AT AN ENDPOINT” and filed on 17 Aug. 2020, the entirety of which is incorporated by reference herein.

### BACKGROUND

In device ecosystems, multiple devices each having respective capabilities are networked together to provide their capabilities to one or more users. Traditionally, to add a new capability to the device ecosystem, a new device is added to the network and performs the new capability when requested by the network. However, adding a new device to the device ecosystem can be cumbersome and restrictive due to limited operating systems and communication protocols being supported by the device ecosystem, such as in a closed device ecosystem. Additionally, continually adding devices to the device ecosystem increases the complexity of managing the capabilities of each device within the device ecosystem.

Often, devices added to a device ecosystem are tied to user data restricting which device ecosystems the device may be added to. Further, many device ecosystems are configured to communicate using a small number of communication protocols which again restricts which devices may be added to a particular device ecosystem.

### SUMMARY OF THE EMBODIMENTS

According to one example embodiment, a method includes receiving, by a first endpoint device from a second endpoint device, a list of available system services associated with the second endpoint device. Further, the method can include receiving an available resolution for at least one available system service from the list of available system services. The method can additionally include executing, by the first endpoint device, one or more applications associated with a functionality.

Executing the one or more application can include transmitting, from the first endpoint device to the second endpoint device, data implementing the functionality using at least one available system from the list of available system services based on the available resolution.

The method can also include receiving, by the first endpoint device, a plurality of available resolutions from the second endpoint device based on at least the one available system service from the list of available system services. The available resolution can be one of the plurality of available resolutions. Additionally, the method can include receiving, by the first endpoint device from the second endpoint device, data representing an interaction with the one or more applications and modifying, by the first endpoint device, the execution of the one or more applications based on the data representing the interaction with the one or more applications.

The method can further include receiving, by the first endpoint device from the second endpoint device, a second list of available system services associated with a third endpoint device communicatively coupled to the second endpoint device. Also, the method can include requesting, by the first endpoint device from the second endpoint device, a second available resolution for a system service from the second list of available system services. Executing the one or more applications can also include transmitting, by the first endpoint device to the third endpoint device, data implementing the functionality using the system service from the second list of available system services based on the second available resolution.

Additionally, the method can include detecting, by the first endpoint device, the second endpoint device and receiving, by the first endpoint device from the second endpoint device, resolution service data associated with the second endpoint device. The method further can include requesting, by the first endpoint device from the second endpoint device, the list of available system services associated with the second endpoint device via a communication protocol of a plurality of communication protocols based on the resolution service data.

In another example embodiment, a method includes detecting, by a first endpoint device, a second endpoint device including one or more system services and receiving, by the first endpoint device, an available resolution associated with the one or more system services of the second endpoint device. The method can also include executing, on the first endpoint device, one or more applications using the one or more system services of the second endpoint device based on the available resolution associated with the one or more system services.

The method can additionally include receiving resolution service data from the second endpoint device and requesting, by the first endpoint device, a list including the one or more system services via a communication protocol based on the resolution service data. Further, the method can include receiving, by the first endpoint device, data representing an interaction with the one or more applications from the second endpoint device and executing the one or more applications based on the data representing the interaction with the one or more applications. The available resolution can be one of a plurality of available resolutions received from the second endpoint device. Also, the second endpoint device can be detected by a first communication protocol and the available resolution can be received by a second communication protocol.

Additionally, the method can include, in response to detecting the second endpoint device, requesting, by the first endpoint device, access to a discovery service engine of the second endpoint device. Further the method can include receiving, at the first endpoint device, a resolution service data associated with the discovery service engine of the second endpoint device and accessing the discovery service engine of the second endpoint device based on the resolution service data. Also, the method can include accessing the discovery service engine of the second endpoint device by a communication protocol of a plurality of communication protocols based on the resolution service data.

Generally, for methods herein, one or more applications can be configured to render one or more notifications. Also, executing the one or more applications can include rendering one or more notifications on a display electronically coupled to the second endpoint device. Further, in general, the first endpoint device can have a first operating system and the second endpoint device can have a second operating system distinct from the first operating system. The second operating system can have at least one different interface, language, memory management technique, communication protocol, encryption, or network stack from the first operating system. Generally, the second endpoint device can be proximate to the first endpoint device. Additionally, the second endpoint device can include a device ID data of a third endpoint device.

According to example embodiments, a system can include a first endpoint device including one or more processors and storing executable instructions configured to manipulate the one or more processors to perform the methods disclosed herein.

According to additional example embodiments, a system can include an endpoint device framework including one or more endpoint devices communicatively coupled to one or more other endpoint devices, the system configured to perform the methods disclosed herein.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an endpoint device framework for shared system services, in accordance with some embodiments.

FIG. 2 is a block diagram of an endpoint device configured to import and export one or more system services within the endpoint device framework of FIG. 1, in accordance with some embodiments.

FIG. 3 is a flow diagram illustrating an example bootstrapping operation of an endpoint device, in accordance with some embodiments.

FIG. 4 is a block diagram of communicatively coupled endpoint devices configured to share one or more system services within the endpoint device framework of FIG. 1, in accordance with some embodiments.

FIG. 5 is a signal flow diagram illustrating an example discovery service access request operation for an endpoint device, in accordance with some embodiments.

FIG. 6 is a signal flow diagram illustrating an example available system services request, in accordance with some embodiments.

FIG. 7 is a flow diagram illustrating a process for executing an application using shared system services, in accordance with some embodiments.

### DETAILED DESCRIPTION

Techniques and systems described herein address providing flexibility in a device ecosystem of endpoint devices through the sharing of system services across one or to more endpoint devices. Specifically, such techniques and systems described herein allow an endpoint device to gain the capabilities of system services shared from one or more other endpoint devices. To gain these capabilities, a first endpoint device running an application detects one or more other endpoint devices communicatively coupled to the first endpoint device. For example, the first endpoint device detects one or more other endpoint devices near or proximate to the first endpoint device. From each of the detected endpoint devices, the first endpoint device requests a respective list of available system services. After determining one or more applicable system services based on the application being run, the first endpoint device requests the data needed to access the applicable system services from the respective endpoint devices. The endpoint device then implements the functionality of the application using one or more of the applicable system services. In this way, the first endpoint device gains the capabilities of the applicable system services shared from the other endpoint devices.

Additionally, the techniques and systems as described herein allow for operating system agnostic system service sharing between endpoint devices. That is to say, an endpoint device having a first operating system can share system services with one or more endpoint devices having one or more different operating systems. Such a framework allows for more flexibility in adding endpoint devices to a device ecosystem.

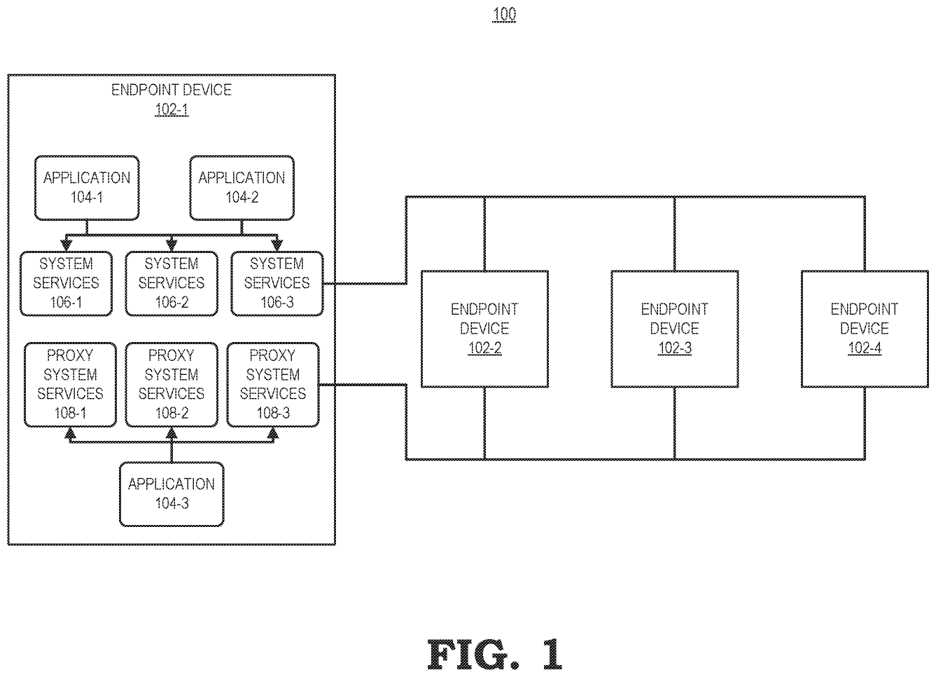

FIG. 1 illustrates an endpoint device framework 100 allowing for shared system services, according to some embodiments. Endpoint device framework 100 includes one or more endpoint devices 102 each communicatively coupled to at least one other endpoint device and is configured to allow the sharing of system services 106 between the communicatively coupled endpoint devices. “Communicatively coupled” as used herein, includes two or more devices each configured to allow the transmission of data, reception of data, or both between them, for example, by wired communications, wireless communications, networked communications, bridged communications, or the like, to name a few. An “endpoint device,” as used herein, includes hardware and software resources configured to run one or more applications 104 and includes, for example, one or more desktop computers, servers, virtual servers, notebook computers, tablet computers, virtual-reality systems, augmented reality systems, a compute-enabled cellular phone (i.e., a “smartphone”), compute-enabled wearable devices (i.e., a “wearables”), a communication hub, a vehicle-integrated display, a compute-enabled display (i.e., a “smart display”), a compute-enabled television, (i.e., a “smart TV”), or any combination thereof.

In embodiments, each application 104 is associated with one or more functionalities that are implemented by the endpoint device 102 when executing the application 104. For example, each application 104 includes logic to implement one or more functionalities. Such functionalities include, for example, streaming video data, streaming audio data, controlling data streams, playback controls, generating notifications, displaying notifications, or any combination thereof, to name a few. To implement these functionalities, each endpoint device 102 includes one or more system services 106 configured to implement at least a portion of a functionality when the application 104 is executed. A “system service,” as used herein, includes hardware and software of an endpoint device 102 configured to implement at least a portion of a functionality of an application 104. For example, a system service 106 includes hardware and software configured to render audio data (e.g., one or more audio encoders, audio decoders, speakers), render video data (e.g., one or more video encoders, one or more video decoders, displays), receive data, transmit data, receive inputs, receive interactions (e.g., interactive touch screen, mouse, keyboard, game controller), generate queries, or any combination thereof, to name a few. As another example, a system service 106 comprises one or more application interface interfaces (APIs) configured to implement one or functionalities of an application 104 executed on an endpoint device 102. Though in the illustrated embodiment, three system services 106-1, 106-2, and 106-3 are presented for implementing functionalities associated with two applications 104-1 and 104-2, in other embodiments, any number of system services may implement functionalities for any number of applications.

According to embodiments, each endpoint device 102 is configured to export one or more system services 106 to one or more other endpoint devices to allow the access and control of (i.e., expose) the exported system services 106 to the one or more other endpoint devices. Each system service 106 of an endpoint device 102 is configured to export one or more system services 106 to one or more other endpoint devices using one or more communication protocols, wired communication connections, and wireless communication connections, for example, Bluetooth, Bluetooth Low Energy (BLE), Multicast Domain Name System (mDNS), QR code, Ultra-Wide Band, Ultrasound, Generic Web Service API, USB, radio frequency identification (RFID), Near-field Communication (NFC), Short Message Service (SMS), Wi-Fi, the Internet, local area network (LAN), Ethernet, or any combination thereof. In embodiments, once a first endpoint device (e.g., endpoint device 102-1) has exported a system service 106 to a second endpoint device (e.g., endpoint device 102-2), the second endpoint device can access and control the system service 106 so as to, for example, implement a least a portion of one or more functionalities associated with applications 104 running on the second endpoint device. That is to say, the second endpoint device uses the system service 106 of the first endpoint device to implement functionalities of the applications 104 running on the second endpoint device. For example, in the illustrated embodiment, system service 106-3 can be exported to endpoint devices 102-2, 102-3, or 102-4 and can be used to implement at least a portion of a functionality of respective applications running on endpoint devices 102-2, 102-3, or 102-4. By exporting one or more system services 106 to one or more other endpoint devices, the one or more other endpoint devices effectively gain new capabilities associated with the hardware and software of the exported system services 106.

In embodiments, each endpoint device 102 includes one or more proxy system services 108 that include software and hardware configured to access and control one or more exported system services 106 from one or more other endpoint devices. According to embodiments, a proxy system service 108 is configured to implement at least a portion of one or more functionalities of an application 104 (also referred to herein as a “supported application”) using one or more exposed system services from another endpoint device. In embodiments, a proxy system service 108 implements the functionality of a supported application by transmitting data implementing the functionality associated with the supported application to the exposed system service 106. For example, proxy system service 108 transmits data representing the logic of an application 104 to implement a functionality associated with the application 104 using an exported system service 106 from another endpoint device. Though in the illustrated embodiment three proxy system services 108-1, 108-2, and 108-3 are demonstrated implementing the functionality of one supported application 104-3 using three endpoint devices 102-2, 102-3, and 102-4, in other embodiments, any number of proxy system services may be used to implement the functionality of any number of applications executing on any number of endpoint devices. In this way, at least a portion of an application executed on a first endpoint device can be implemented on a second endpoint device. For example, an application 104 executed on a first endpoint device 102-1 may have a functionality including the generation and display of notifications. Here, at least a portion of the application 104 running on the first endpoint device 102-1, for example, the display of notifications, can be implemented on a second endpoint device 102-2.

According to embodiments, proxy system services 108 are configured to receive input data from one or more exported system services 106 from other endpoint devices. “Input data,” as used here, includes data representing interactions (e.g., gestures on a touchscreen, taps on a touch screen, entered text, mouse clicks, button presses, to name a few) on an input device, for example, an interactive touch screen, mouse, keyboard, or game controller, to name a few. In embodiments, each proxy system service 108 is configured to modify the execution of a supported application based on the input data. For example, a proxy system service 108 provides the input data as an input to the supported application. As another example, proxy system services 108 initiate or halt the execution of the supported application based on the input data.

In embodiments, each endpoint device 102 of endpoint device framework 100 includes one or more operating systems each having, for example, one or more interfaces, languages, memory management techniques, communication protocols, encryptions, network stacks, or any combination thereof, to name a few. According to embodiments, the endpoint device framework 100 is configured to be operating system agnostic. “Operating system agnostic,” as used herein, includes endpoint device framework 100 configured to support at least one endpoint device 102 having a first operating system and at least one other endpoint device having a second, distinct operating system. That is to say, within endpoint device framework 100 a first endpoint device 102 with a first operating system can export or import one or more system services 106 to a second endpoint device with a second, different operating system that includes one or more different interfaces, memory management techniques, communication protocols, network stacks, or any combination thereof, from the first operating system.

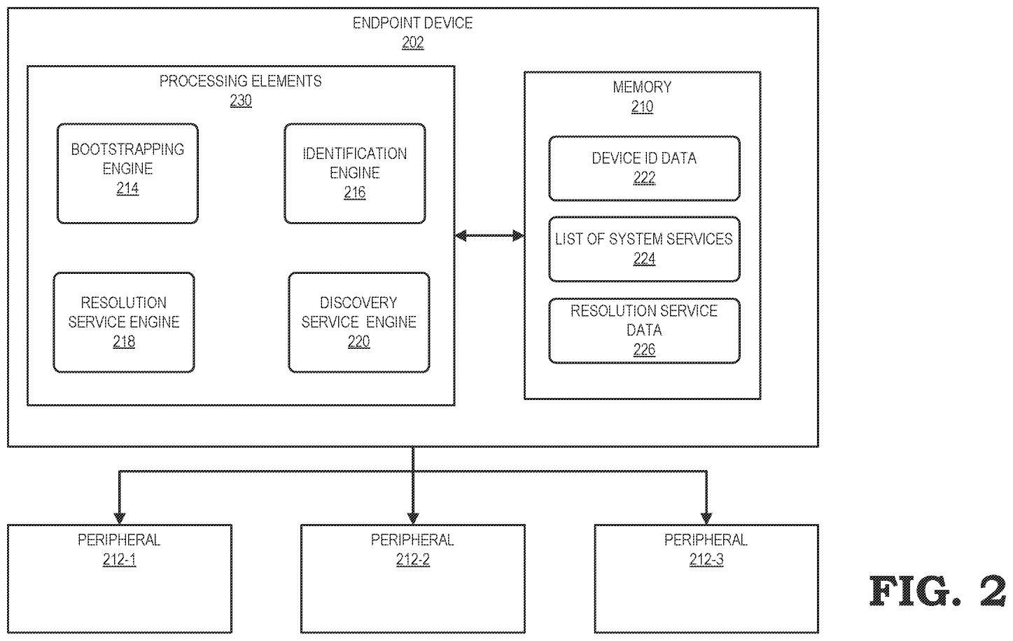

For example, a first endpoint device (e.g., endpoint device 102-1) includes a first operating system having a first interface and a first memory management system. Within the endpoint device framework 100, the first endpoint device can import one or more system services from a second endpoint device having a second, different operating system with a second, distinct interface and a second, distinct memory management system. As discussed below with reference to FIG. 2, the first endpoint device can request access to one or more system services 106 on the second endpoint device. In response, the second endpoint device transmits data indicating how to access the system services 106 according to the operating system running on the second endpoint device. In other words, the second endpoint device transmits data indicating how to access its system services 106 according to the one or more interfaces, memory management techniques, communication protocols, network stacks, or any combination thereof, of the second operating system. From this data, the first endpoint device can then access the system services of the second endpoint device.

Referring now to FIG. 2, an example endpoint device 202 configured to share system services is presented. In embodiments, endpoint device 202 implements aspects of endpoint device framework 100 as described in FIG. 1. For example, endpoint device 202 may be similar or the same as an endpoint device 102 described in FIG. 1. Endpoint device 202 includes hardware and software for the exportation and importation of one or more system services to and from one or more other endpoint devices, respectively. According to some embodiments, endpoint device 202 is part of an electronic device that supports the exportation and importation of system services to and from one or more other endpoint devices, including, for example, a desktop computer, a notebook computer, a tablet computer, a virtual-reality system, an augmented reality system, a smartphone, a communication hub, a smart display, or a smart tv, to name a few. In embodiments, endpoint device 202 includes or is communicatively coupled to one or more peripherals 212, for example, displays, input devices, speakers, lights (e.g., light-emitting diodes (LEDs), organic light-emitting diodes (OLEDs)), or any combination thereof. Though in the illustrated embodiment endpoint device 202 is communicatively coupled to three peripherals 212-1, 212-2, and 212-3, in other embodiments, endpoint device 202 may be communicatively coupled to any number of peripherals.

In embodiments, endpoint device 202 includes processing elements 230 communicatively coupled to memory 210. Memory 210 includes an electronic storage device, for example, a solid-state drive, a hard disk drive, random access memory (“RAM”), read-only memory (“ROM”), electronically erasable programmable ROM (“EEPROM”), optical storage device, or any combination thereof. Memory 210 includes instructions and data related to the execution of one or more applications and the exportation and importation of system services from one or more endpoint devices, for example, device ID data 222, list of system services 224, and resolution service data 226.

According to embodiments, processing elements 230 include one or more control processing units (“CPUs”), microprocessors, field-programmable gate arrays (“FPGAs”), graphics processing units (“GPUs”), application-specific integrated circuits (ASICs), or any combination thereof and are configured to import and export one or more system services to and from one or more other endpoint devices. In embodiments, endpoint device 202 includes a list of system services 224 stored in memory 210. The list of system services 224 includes data indicating the system services 106 available to endpoint device 202. The system services available to endpoint device 202 include the system services 106 included in endpoint device 202 as well as the system services exported to the endpoint device 202 from one or more other endpoint devices (i.e., system services of other endpoint devices controlled by one or more proxy system services 108). According to embodiments, the list of system services 224 can further include system services available to one or more other endpoint devices communicatively coupled to endpoint device 202.

According to embodiments, memory 210 includes resolution service data 226 including the available resolutions associated with one or more components of endpoint device 202 (e.g., bootstrapping engine 214, identification engine 216, discovery service engine 220, peripherals 212), one or more system services in the list of system services 224, or both. “Available resolutions,” as used herein, includes data indicating how one or more components of endpoint device 202 or system services 106 of endpoint device 202 can be accessed using one or more communication protocols. For example, an available resolution includes data indicating one or more addressable locations for a system service 106 usable by one or more protocols (e.g., internet protocol, ports, Bluetooth Generic Attribute Profile (GATT), to name a few). In embodiments, an available resolution includes multiple addressable locations usable by two or more communication protocols. In this way, the resolution service data 226 includes data indicating how to access a system service 106 using multiple communication protocols. According to embodiments, resolution service data 226 includes available resolutions for one or more of the system services 106 available to endpoint device 202 including the system services exported to the endpoint device 202 from one or more other endpoint devices. In embodiments, resolution service data 226 further includes available resolutions for one or more system services available to one or more other endpoint devices communicatively coupled to endpoint device 202.

Processing elements 230 include bootstrapping engine 214 configured to perform a bootstrapping operation to discover and initiate contact with one or more other endpoint devices to the endpoint device 202. According to embodiments, the bootstrapping operation of bootstrapping engine 214 includes a detection stage configured to detect the presence of one or more endpoint devices proximate to the endpoint device 202. As used herein, an endpoint device is proximate to the endpoint device 202 when it is discoverable by bootstrapping engine 214 using one or more protocols, for example, BLE, mDNS, or NFC, to name a few. That is to say, a proximate endpoint device is within a distance away from the endpoint device 202 that still allows for its detection by bootstrapping engine 214. In embodiments, the detection stage of bootstrapping engine 214 is configured to detect the presence of one or more endpoint devices communicatively coupled or associated with the endpoint device 202, for example, by one or more accounts (e.g., one or more endpoint devices sharing a user account with the endpoint device 202), a server (e.g., one or more endpoint devices registered with a server), to name a couple. According to embodiments, the bootstrapping operation of bootstrapping engine 214 further includes an initialization stage configured to query and return device identification data (device ID data) from one or more detected endpoint devices.

In embodiments, memory 210 includes device ID data 222 comprising a device ID of endpoint device 202 that indicates the identity, ownership, access, attestations, or any combination thereof, of endpoint device 202. According to embodiments, the device ID includes an addressable label for endpoint device 202 similar to an internet protocol (“IP”) address. According to embodiments, endpoint devices are configured to communicate with other endpoint devices (e.g., endpoint device 202) by providing their device IDs and addressable labels to one another. In embodiments, the device ID includes the public half of an asymmetric keypair. According to embodiments, an endpoint device (e.g., endpoint device 202) is configured to use the keypair for digital signatures. In this way, an endpoint device that receives the digital signature from a second endpoint device can verify the signatures of the second endpoint device. In embodiments, a device ID includes an attestation token that includes one or more attestations of an endpoint device. An attestation includes data representing one or more capabilities, configurations, or integrities of an endpoint device. For example, an attestation can include data indicating that the system software of the endpoint device has not been modified since its manufacture. In an example embodiment, a device ID is 32 bytes in length, while in other embodiments, a different number of bytes may be used. According to embodiments, a device ID further includes communication information, for example, address information for one or more system services, engines, modules, or processors of the endpoint device and one or more communication protocols supported by the endpoint device or its one or more system services, engines, modules, or processors. As an example, a device ID for endpoint device 202 can include communication information indicating how to access resolution service engine 218 (e.g., one or more addressable locations of resolution service engine 218) and the communication protocols supported by resolution service engine 218. In embodiments, device ID data includes the device IDs for one or more other endpoint devices, for example, those that endpoint device 202 is communicatively coupled to, was previously communicatively coupled to, or both.

According to embodiments, processing elements 230 include identification engine 216 configured to generate, store, modify, maintain, and authenticate device IDs, for example, those stored in device ID data 222. In embodiments, identification engine 216 is configured to authenticate a device ID received from one or more endpoint devices. For example, identification engine 216 is configured to confirm the ownership of a device ID, confirm the address of a device ID, confirm an attestation of the device ID (e.g., that the endpoint device has not been tampered with), for example, by an attestation service, confirm the identity of a device ID, determine a timestamp for the device ID, or any combination thereof. As an example, identification engine 216 confirms the identity of a received device ID by comparing an identity indicated in the received device ID to an identity obtained from an attestation service. As another example, a device ID can comprise a public half of an asymmetric keypair used in digital signatures allowing identification engine 216 to verify signatures received from the endpoint device associated with the device ID. Identification engine 216 is configured to store one or more received device IDs in device ID data 222. According to embodiments, identification engine 216 only stores authenticated device IDs in device ID data 222.

In embodiments, processing elements 230 include resolution service engine 218 that includes software and hardware configured to handle incoming discovery access resolution requests and resolution queries received from one or more other endpoint devices. As used herein, a “discovery access resolution request” comprises a request for access to the discovery service engine 220 of endpoint device 202 that is received from one or more other endpoint devices. Based on the discovery access resolution request, resolution engine 218 is configured to transmit one or more available resolutions associated with discovery service engine 220 to the endpoint devices that sent the discovery access resolution request. That is to say, resolution engine 218 is configured to transmit data indicating how to access discovery service engine 220 using one or more communication protocols to the requesting endpoint devices. As used herein, a “resolution query” comprises a request for access to one or more identified system services contained in the list of system services 224. Based on received resolution queries, resolution engine 218 is configured to transmit one or more available resolutions associated with the identified system services to the endpoint devices that sent a resolution query. In other words, resolution engine 218 is configured to transmit data indicating how to access the identified system services (e.g., one or more addressable locations) using one or more communication protocols to the requesting endpoint devices.

According to embodiments, processing elements 230 include discovery service engine 220 that includes hardware and software configured to handle incoming system services queries received from one or more other endpoint devices. A “system services query”, as used herein, comprises a request for the identification or list of one or more system services available to endpoint device 202. Based on the received system services query, discovery service engine 220 accesses the list of system services 224 and determines the system services available to endpoint device 202. According to embodiments, discovery service engine 220 is configured to transmit data including the list of available system services to the requesting endpoint device. In embodiments, discovery service engine 220 is further configured to transmit one or more additional lists of available system services to a requesting endpoint device. Each additional list of available system services indicates the system services available to a respective endpoint device communicatively coupled to endpoint device 202. In this way, endpoint device 202 functions as an intermediary or bridge between the requesting endpoint device and the endpoint device communicatively coupled to endpoint device 202.

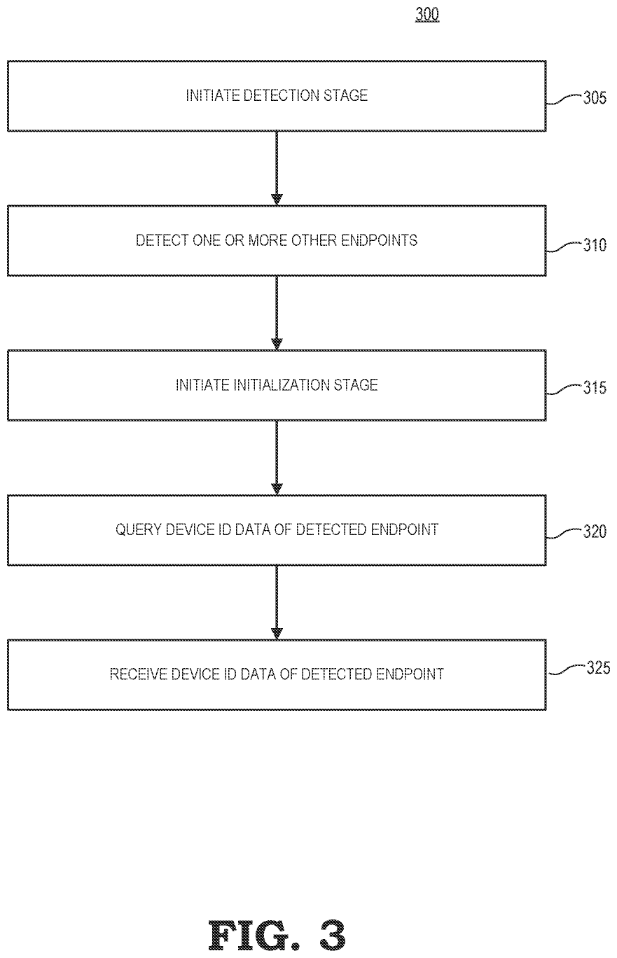

FIG. 3 presents an example bootstrapping operation 300 performed by a bootstrapping engine, similar or the same as bootstrapping engine 214, of a first endpoint device, similar or the same as endpoint device 202 is presented. At step 305, the bootstrapping engine initiates the detection stage. In embodiments, initiating the detection stage includes the bootstrapping engine initiating (e.g., activating) one or more communication protocols, for example, Bluetooth, BLE, Multicast Domain mDNS, QR code, Ultra-Wide Band, RFID, NFC, or any combination thereof, to name a few. At step 310, the bootstrapping engine detects one or more proximate endpoint devices according to one or more of the initiated protocols. In embodiments, one or more of the initiated protocols include a first device operating as a scanning device (e.g., the first endpoint device) and a second device operating as an advertising device (e.g., one or more other endpoint devices). An “advertising device,” as used herein, is configured to announce its presence based on one more of the initiated protocols. For example, an advertising device is configured to transmit a signal or beacon indicating the presence of the advertising device according to one or more of the initiated protocols. A “scanning device,” as used herein, is configured to detect the presence of one or more advertising devices, for example, by receiving the signals or beacons transmitted by the advertising devices. According to embodiments, a single device may concurrently operate as a scanning device and an advertising device.

At step 315, after the bootstrapping engine has detected the presence of one or more endpoint devices, the bootstrapping engine initiates the initialization stage. At the initialization stage, the bootstrapping engine is configured to initiate contact with one or more detected endpoint devices using one or more communication protocols. In embodiments, the bootstrapping engine initiates contact with one or more detected endpoint devices using one or more of the initiated protocols. At step 320, once the bootstrapping engine has initiated contact with the detected endpoint devices, the bootstrapping engine builds and transmits a device ID query to the detected endpoint devices. The device ID query includes a request for the device ID of the connected endpoint devices. That is to say, the bootstrapping engine requests identification data from each detected endpoint device. According to some embodiments, the device ID query includes the device ID of the endpoint device initiating the bootstrapping process. At step 325, the bootstrapping engine receives the respective device IDs from one or more detected endpoint devices. According to some embodiments, the bootstrapping engine further receives one or more device IDs from a detected endpoint device identifying one or more respective endpoint devices coupled to the detected endpoint device. In embodiments, the bootstrapping engine may provide the received device IDs to an identification engine similar to or the same as identification engine 216. The identification engine is configured to authenticate the device ID, for example, by confirming the ownership of a device ID, confirming the address of a device ID, confirming an attestation of the device ID by an attestation service, confirming the identity of a device ID, determining a timestamp for the device ID (e.g., to confirm that the device ID is not expired) or any combination thereof. According to embodiments, the device IDs received from the detected endpoint devices each include one or more available resolutions associated with a respective discovery service engine of the connected endpoint devices (i.e., data indicating how to access the respective discovery service engines of the connected endpoint devices).

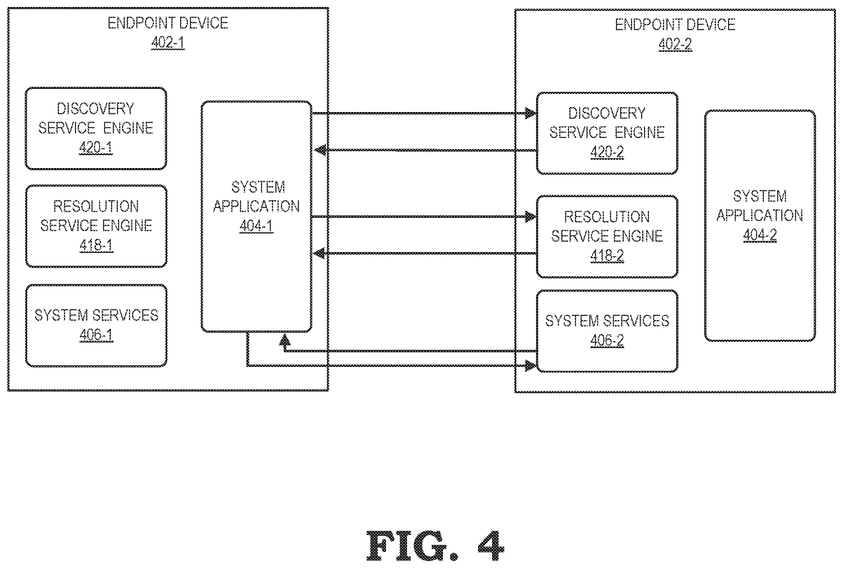

Referring now to FIG. 4, a block diagram of communicatively coupled endpoint devices configured to share system services is presented. In embodiments, endpoint devices 402-1 (including discovery service engine 420-1, resolution service engine 418-1, and system services 406-1) and 402-2 (including discovery service engine 420-2, resolution service engine 418-2, and system services 406-2) implement aspects of endpoint device framework 100 as described in FIG. 1. For example, endpoint devices 402-1 and 402-2 may be similar or the same as an endpoint device 102 described in FIG. 1. Though in the illustrated embodiment endpoint device 402-1 is communicatively coupled to one other endpoint device 402-2, in other embodiments, endpoint device 402-1 may be communicatively coupled to any number of other endpoint devices. According to embodiments, endpoint device 402-1 initiates contact with endpoint device 402-2 using one or more communication protocols by implementing, for example, example bootstrapping operation 300 discussed above with reference to FIG. 3.

In embodiments, each endpoint device 402 is configured to run or execute one or more applications 404-1 and 404-2, respectively, each associated with one or more functionalities. Each endpoint device is configured to implement these functionalities using the system services 406 within or native to the endpoint device 402 or using one or more exported system services 406 shared from another endpoint device 402. For example, in the illustrated embodiment, endpoint device 402-1 is configured to implement one or more functionalities of application 404-1 using system services 406-1, system services 406-2 on endpoint device 402-2, or both. In this way, the capabilities of the endpoint device 402-1 are increased as more system services are available to implement the functionalities of an application. According to embodiments, to access the system services 406 on another endpoint device, one or more applications 404 running on an endpoint device 402 are configured to access the discovery service engine 420, similar or the same as discovery service engine 220, of one or more other endpoint devices. Though in the illustrated embodiment one application 404-1 running of a first endpoint device 402-1 is accessing one discovery service engine 420-2 of one other endpoint device 402, in other embodiments, any number of applications 404 running one the first endpoint device 402-1 may access any number of discovery services engines of any number of other endpoint devices. In some embodiments, an application 404 operating on a first endpoint device 402-1 accesses a discovery service engine 420-2 operating on a second endpoint device 402-2 based on a device ID received from the second endpoint device 402-2 during a bootstrapping operation, similar or the same as bootstrapping operation 300. For example, during the bootstrapping operation, endpoint device 402-1 receives a device ID from endpoint device 402-2 that includes one or more available resolutions associated with discovery service engine 420-2 operating on endpoint device 402-2 (i.e., data indicating how to access discovery service engine 420-2). Based on these available resolutions, application 404-1 may access discovery service engine 420-2 using one or more communication protocols. In embodiments, endpoint device 402-1 receives a device ID from endpoint device 402-2 that includes one or more available resolutions associated with one or more discovery service engines of one or more other endpoint devices communicatively coupled to endpoint device 402-2. In other embodiments, application 404-1 operating on the first endpoint device 402-1 first requests access to the discovery service engine 420-2 by querying the resolution service engine 418-2 operating on endpoint device 402-2.

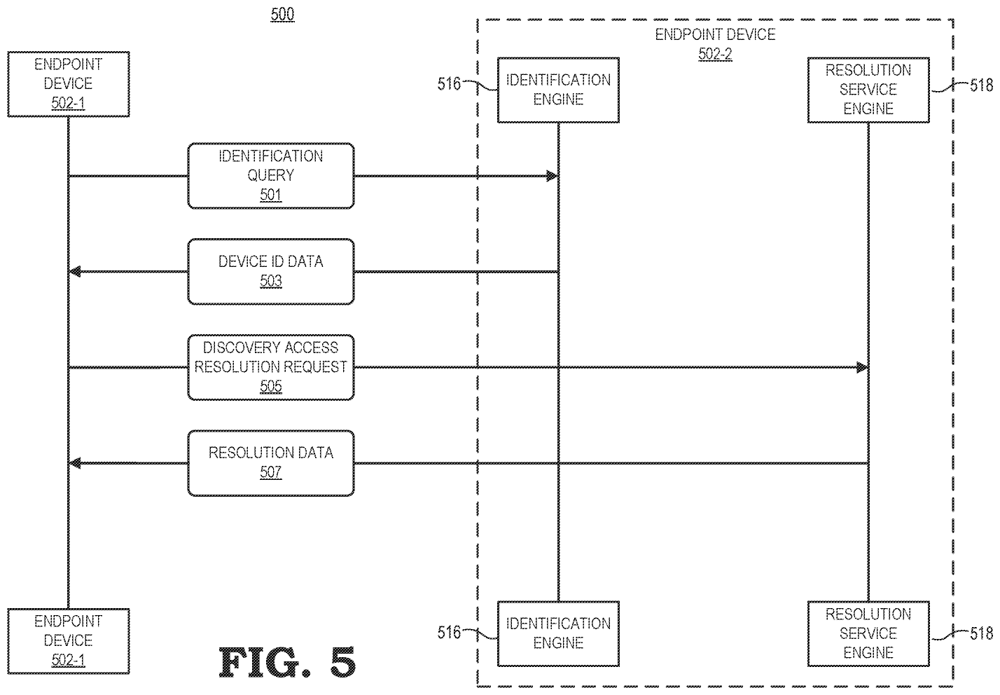

For example, referring now to FIG. 5, an example request operation 500 for access to a discovery service engine is presented. According to embodiments, a first endpoint device 502-1, similar or the same as endpoint device 102, is configured to request access to a discovery service engine, similar or the same as discovery service engine 220, operating on a second endpoint device 502-2 that is communicatively coupled to the first endpoint device 502-1. The second endpoint device 502-2 includes a resolution service engine 518, similar or the same as resolution service engine 218, and an identification engine 516, similar or the same as identification engine 216. The request operation 500 includes the first endpoint device 502-1 transmitting an identification query 501 to the second endpoint device 502-2. In embodiments, the identification query 501 includes data requesting the device ID of the second endpoint device 502-2. According to embodiments, in response to receiving the identification query 501, the identification engine 516 of the second endpoint device 502-2 is configured to transmit the device ID data 503 of the second endpoint device 502-2 to the first endpoint device 502-1. The device ID data 503 transmitted to the first endpoint device 502-1 includes data indicating how to access the resolution service engine 518 of the second endpoint device 502-2. For example, the device ID data 503 includes data indicating the communication protocols supported by the resolution service engine 518, an addressable location of the resolution service engine 518, or both.

Based on the received device ID data 503, the first endpoint device 502-1 generates a discovery access resolution request 505 and transmits the discovery access resolution request 505 to the resolution service engine 518 of the second endpoint device 502-2. The discovery access resolution request 505 includes data requesting access information for the discovery service engine running on the second endpoint device 502-2. For example, the discovery access resolution request 505 includes a query of the available resolutions for the discovery service engine of the second endpoint device 502-2. In response to receiving the discovery access resolution request 505, the resolution service engine 518 is configured to transmit the resolution data 507 to the first endpoint device. The resolution data 507 includes one or more available resolutions for the discovery service engine of the second endpoint device 502-2. That is to say, the resolution data 507 includes data indicating how to access the discovery service engine of the second endpoint device 502-2. For example, the resolution data 507 includes one or more communication protocols supported by the discovery service engine and an addressable location of the discovery service engine. From the resolution data 507, the first endpoint device 502-1 can access the discovery service engine of the second endpoint device 502-2. For example, the resolution data 507 can include data identifying a communication protocol supported by the discovery service engine of the second endpoint device (e.g., Bluetooth LTE) and one or more open ports on which the discovery service engine is available. Based on the identified communication protocol and open ports, the first endpoint device 502-1 can access the discovery service engine of the second endpoint device 502-2. In embodiments, the resolution data 507 further includes one or more available resolutions for the discovery service engines of one or more endpoint devices communicatively coupled to the second endpoint device 502-2.

Referring again to FIG. 4, after gaining access to the discovery service engine 420-2 of the second endpoint device 402-2, the application 404-1 running on the first endpoint device 402-1 queries and receives a list of available system services from the discovery service engine 420-2. The list of available system services includes each system service available to the second endpoint device 402-2 including those exported to (i.e., shared with) the second endpoint device 402-2 by one or more other endpoint devices. According to some embodiments, the first endpoint device 402-1 queries and receives from the discovery service engine 420-2, one or more additional lists of available system services that include system services available to one or more respective other endpoint devices communicatively coupled to second endpoint device 402-2. In this way, discovery service engine 420-2 acts as a bridge or intermediary between the first endpoint device 402-1 and one or more other endpoint devices communicatively coupled to the second endpoint device 402-2.

In embodiments, the application 404-1 determines one or more applicable system services from the one or more lists of available system services based on the functionalities associated with one or more applications run on the first endpoint device 402. Here, an applicable system service includes a system service that assists in or is necessary for the implementation of one or more functionalities associated with the applications running on the endpoint device. For example, application 404-1 determines one or more applicable system services from the list of system services that assist in or are necessary for the implementation of one or more functionalities associated with the application 404-1. After determining the applicable system services, the application 404-1 queries the resolution service engine 418-2 of the second endpoint device 402-2 for available resolutions associated with the applicable system services. Put another way, the application 404-1 requests data indicating how to access the applicable system services from the resolution service engine 418-2.

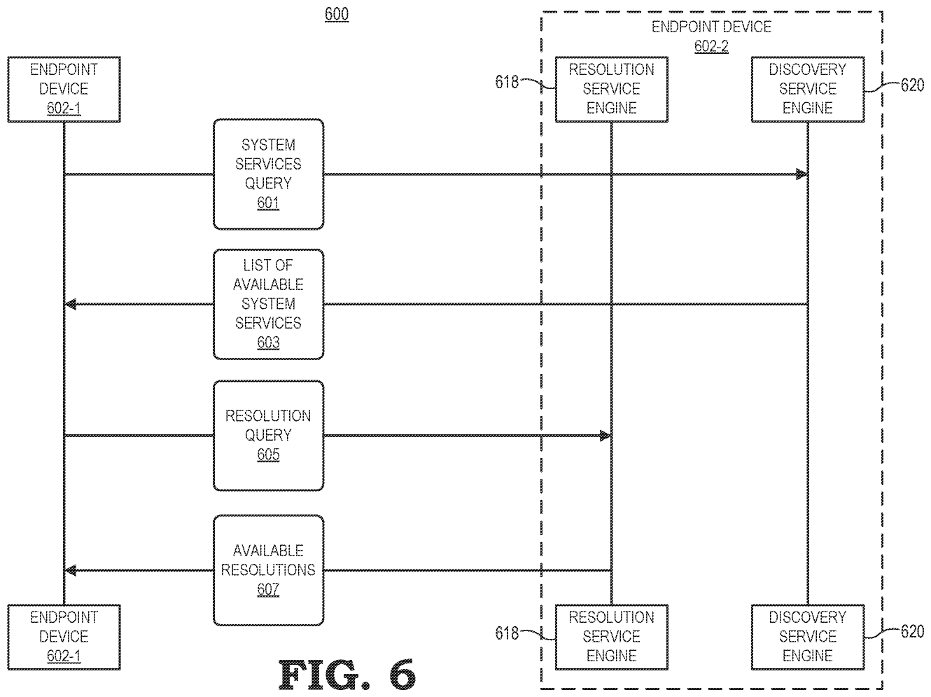

For example, referring now to FIG. 6, an example request operation 600 for available system services from an endpoint device is presented. In embodiments, a first endpoint device 602-1, similar or the same as endpoint device 102, generates and transmits a system services query 601 to the discovery service engine 620 of a second endpoint device 602-2. The system services query 601 includes data requesting a list of system services available to the second endpoint device 602-2. In response to receiving the system services query 601, the discovery service engine 620 operating on the second endpoint device 602-2 transmits a list of available system services 603 to the first endpoint device 602-1. The list of available system services 603 includes data identifying each system service available to the second endpoint device 602-2. Such system services include the system services operating on the second endpoint device 602-2 as well as the system services exported to, or shared with, the second endpoint device 602-2 by one or more other endpoint devices. According to some embodiments, the second endpoint device 602-2 transmits one or more additional lists of available system services that each include data identifying the system services available to respective other endpoint devices communicatively coupled to the second endpoint device 602-2. Based on the list of available system services 603 or one or more additional lists of available system services, the first endpoint device 602-1 determines one or more applicable system services based on one or more functionalities of the applications running on the first endpoint device 602-1.

After the first endpoint device 602-1 has determined one or more applicable applications, the first endpoint device 602-1 generates and transmits a resolution query 605 to the resolution service engine 618 of the second endpoint device 602-2. The resolution query 605 includes data requesting how to access the determined applicable system services (i.e., requesting one or more available resolutions for the applicable system services). In response to receiving the resolution query 605, the resolution service engine 618 of the second endpoint device 602-2 determines one or more available resolutions 607 for the applicable system services. For example, the resolution service engine 618 parses resolution service data to determine one or more available resolutions 607 for the application system services. Once the resolution service engine 618 determines the available resolutions 607 for the applicable system services, the available resolutions 607 are transmitted to the first endpoint device 602-1.

Referring again to FIG. 4, after the application 404-1 running on the first endpoint device 402-1 receives the available resolutions for the applicable system services, application 404-1 accesses those applicable system services of endpoint device 402-2 such that the application 404-1 has control over the applicable system services. After the application 404-1 accesses the applicable system services, the first endpoint device 402-1 executes one or more applications 404 by implementing the functionalities associated with those applications 404 using the applicable system services. For example, the endpoint device 402-1 implements a functionality associated with application 404-1 using system services 406-2 of the second endpoint device 402-2. In embodiments, implementing a functionality of an application includes executing at least a portion of the application using the applicable system services. In this way, the first endpoint device 402-1 gains the capabilities of the system services 406-2 of the second endpoint device 402-2.

As an example, the application 404-1 includes one or more notification functionalities, for example, the generation, display, and interaction of one or more notifications.

From a list of available system services from the second endpoint device 402-2, the application 404-1 determines one or more applicable system services that assist in the display and interaction of one or more notifications, for example, a display API, an input API, and an interface of the second endpoint device 402-2. Once the application 404-1 receives the available resolutions for the display API, input API, and interface of the second endpoint device 402-2, the application 404-1 implements the display of one or more notifications using, for example, the display API and the interface of the second endpoint device 402-2 and implements the interaction with one or more notifications using, for example, the input API and the interface of the second endpoint device 402-2.

As another example, the application 404-1 includes one or more functionalities, for example, the reception and streaming of a phone call. From a list of available system services from the second endpoint device 402-2, the application 404-1 determines one or more applicable system services that assist in the reception and streaming of a phone call, for example, a telecom API of the second endpoint device 402-2. Once the application 404-1 receives the available resolutions for the telecom API of the second endpoint device 402-2, the application 404-1 implements the reception and streaming of a phone call using, for example, the telecom API of the second endpoint device 402-2.

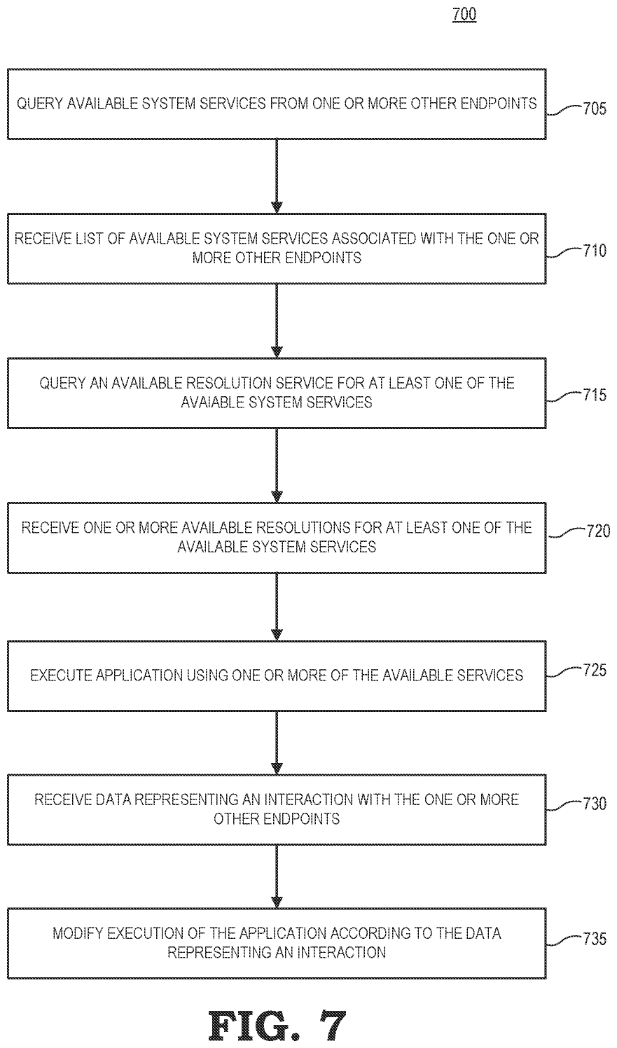

Referring now to FIG. 7, a flow diagram of an example process 700 for executing an application using shared system services is illustrated. At step 705, a first endpoint device, similar or the same as endpoint device 102, first accesses the discovery service engine of one or more other endpoint devices communicatively coupled to the first endpoint device. In embodiments, to access the discovery service engines, the first endpoint device is configured to first detect the one or more other endpoint devices according to one or more communication protocols. The first endpoint device then requests the device ID of each detected endpoint device. According to embodiments, each device ID of the detected endpoint device includes data indicating how to access the respective discovery service engine for that endpoint device.

Further at step 705, once the first endpoint device has access to the discovery service engine of one or more other endpoint devices communicatively coupled to the first endpoint device, the first endpoint device queries the available system services for each of the other endpoint devices. That is to say, the first endpoint device queries, from each other endpoint device, the system services running on the other endpoint device as well as the system services exported to (i.e., shared with) the other endpoint device from at least another, different endpoint device. At step 710, the first endpoint device receives a list of available system services from each of the queried endpoint devices. From the lists of available system services, the first endpoint device identifies one or more applicable system services. The applicable system services include one or more system services that assist in or are necessary for the implementation of one or more functionalities associated with one or more applications running on the first endpoint device. At step 715, the first endpoint device queries resolution data for the applicable system services from one or more of the endpoint devices that listed the applicable system services. That is to say, the first endpoint device queries the endpoint devices that transmitted a list of available system services including the applicable system services. At step 720, the first endpoint device receives one or more available resolutions for each of the applicable system services from the respective endpoint devices (i.e., the endpoint devices that were queried). The available resolutions include data indicating how to access and control the applicable system services, for example, data indicating one or more communication protocols associated with an applicable system service and one or more addressable locations of the applicable system service.

At step 725, the first endpoint device executes one or more applications. Executing the one or more applications includes implementing one or more functionalities associated with the applications using one or more of the applicable system services. In this way, the first endpoint device executes an application using the system services of other endpoint devices. At step 730, the first endpoint device receives data representing an interaction with a respective endpoint device including an applicable system service implementing functionalities of the application executing on the first endpoint device. That is to say, the first endpoint device receives data representing interactions with the application executing on the first endpoint device from a second endpoint device that includes applicable system services used in implementing functionalities of the application executing on the first endpoint device. In this way, the second endpoint device functions as a remote input device for the application executing on the first endpoint device. At step 735, the first endpoint device is configured to modify the execution of one or more applications according to the data representing interactions with a respective endpoint device. For example, the first endpoint device provides the data representing interactions with a respective endpoint device as an input to one or more applications, initiates the execution of one or more applications based on the data, halts the execution of one or more applications based on the data, or any combination thereof, to name a few.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

The preposition “or” as used in the context of “at least one of A, B, or C”, is herein used to signify an “inclusive or.” That is to say, in the above and similar contexts, or is used to signify “at least one of or any combination thereof.” For example, “at least one of A, B, and C” is used to signify “at least one of A, B, C, or any combination thereof.”

Benefits, other advantages, and solutions to problems have been described above with regard to specific embodiments. However, the benefits, advantages, solutions to problems and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method, comprising:
receiving, by a first endpoint device from a second endpoint device, a list of available system services associated with the second endpoint device and an available resolution for at least one available system service from the list of available system services; and
executing, by the first endpoint device, one or more applications associated with a functionality, wherein executing the one or more applications comprises transmitting, from the first endpoint device to the second endpoint device, data implementing the functionality using at least one available system from the list of available system services based on the available resolution.

2. The method of claim 1, wherein the method further comprises:
receiving, by the first endpoint device, a plurality of available resolutions from the second endpoint device based on at least the one available system service from the list of available system services,
and wherein the available resolution is one of the plurality of available resolutions.

3. The method claim 1, further comprising:
receiving, by the first endpoint device from the second endpoint device, data representing an interaction with the one or more applications; and
modifying, by the first endpoint device, the execution of the one or more applications based on the data representing the interaction with the one or more applications.

4. The method of claim 1, further comprising:
receiving, by the first endpoint device from the second endpoint device, a second list of available system services associated with a third endpoint device communicatively coupled to the second endpoint device; and
requesting, by the first endpoint device from the second endpoint device, a second available resolution for a system service from the second list of available system services.

5. The method of claim 4, wherein executing the one or more applications further comprises transmitting, by the first endpoint device to the third endpoint device, data implementing the functionality using the system service from the second list of available system services based on the second available resolution.

6. The method of any of claim 1, further comprising:
detecting, by the first endpoint device, the second endpoint device; and
receiving, by the first endpoint device from the second endpoint device, resolution service data associated with the second endpoint device.

7. The method of claim 6, further comprising:
requesting, by the first endpoint device from the second endpoint device, the list of available system services associated with the second endpoint device via a communication protocol of a plurality of communication protocols based on the resolution service data.

8. A method, comprising:
detecting, by a first endpoint device, a second endpoint device including one or more system services;
receiving, by the first endpoint device, an available resolution associated with the one or more system services of the second endpoint device; and
executing, on the first endpoint device, one or more applications using the one or more system services of the second endpoint device based on the available resolution associated with the one or more system services.

9. The method of claim 8, further comprising:
receiving resolution service data from the second endpoint device; and
requesting, by the first endpoint device, a list including the one or more system services via a communication protocol based on the resolution service data.

10. The method of claim 8, further comprising:
receiving, by the first endpoint device, data representing an interaction with the one or more applications from the second endpoint device; and
executing the one or more applications based on the data representing the interaction with the one or more applications.

11. The method of claim 8, wherein the available resolution is one of a plurality of available resolutions received from the second endpoint device.

12. The method of claim 8, wherein the second endpoint device is detected by a first communication protocol and the available resolution is received by a second communication protocol.

13. The method of claim 8, further comprising:
in response to detecting the second endpoint device, requesting, by the first endpoint device, access to a discovery service engine of the second endpoint device.

14. The method of claim 13, further comprising:
receiving, at the first endpoint device, a resolution service data associated with the discovery service engine of the second endpoint device; and
accessing the discovery service engine of the second endpoint device based on the resolution service data.

15. The method of claim 14, further comprising:
accessing the discovery service engine of the second endpoint device by a communication protocol of a plurality of communication protocols based on the resolution service data.

16. The method of claim 8, wherein the one or more applications are configured to render one or more notifications.

17. The method of claim 8, wherein executing the one or more applications comprises rendering one or more notifications on a display electronically coupled to the second endpoint device.

18. The method of claim 8, wherein the first endpoint device has a first operating system and the second endpoint device has a second operating system distinct from the first operating system.

19. The method of claim 18, wherein the second operating system has at least one different interface, language, memory management technique, communication protocol, encryption, or network stack from the first operating system.

20. The method of claim 8, wherein the second endpoint device is proximate to the first endpoint device.

21. The method of claim 8, wherein the second endpoint device includes a device ID data of a third endpoint device.

22. A system comprising:
a first endpoint device including one or more processors and storing executable instructions configured to manipulate the one or more processors to:
receive, from a second endpoint device, a list of available system services associated with the second endpoint device and an available resolution for at least one available system service from the list of available system services; and
execute one or more applications associated with a functionality, wherein executing the one or more applications comprises transmitting, from the first endpoint device to the second endpoint device, data implementing the functionality using at least one available system from the list of available system services based on the available resolution.

23. (canceled)
